(19) United States
(12) Patent Application Publication
(10) Pub. No.: US 2003/0154254 A1
(43) Pub. Date: Aug. 14, 2003

(54) Assisted messaging for corporate email systems

(76) Inventor: Nikhil Awasthi, Perth Amboy, NJ (US)

Correspondence Address: Douglas W. Swartz, SHERIDAN ROSS P.C., Suite 1200, 1560 Broadway, Denver, CO, 80202-5141, US

(21) Appl. No.: 10/076,382

(22) Filed: Feb. 14, 2002

(51) Int. Cl. G06F 15/16

(52) U.S. Cl. 709/206; 709/247; 709/207

(57) ABSTRACT

The present invention is directed to a system for processing a message received from a computational network. The network message includes a header and a body and/or an attachment. The system includes a group assistant 38 to parse the header and the body and/or attachment to locate predetermined types of information, including at least one intended network message recipient, and a message notification agent 42 to assemble the predetermined types of information in a notification message and forward the notification message to the intended network message recipient. The notification message has a smaller byte size than the corresponding network message.

### FIELD OF THE INVENTION

The present invention relates to communication and storage of electronic mail messages and more particularly to a system for managing electronic mail messages.

### BACKGROUND OF THE INVENTION

Electronic mail (e-mail) is one of the most commonly used applications for distributed computer networks. E-mail refers to the transmission of messages, which may include further messages and/or files as attachments, by computer from one person to another. E-mail provides better connectivity and fast communication between network users. If a person is either unavailable or unwilling to pick up a message immediately, the message is stored until that person can review the stored message at a later time. E-mail messages also provide a quick and easy way to package information such as sales reports, graphics, and other data for transfer to another user by simply attaching the information to the message. Business users increasingly rely on e-mail messages to share ideas, transmit documents, schedule meetings, and perform a multitude of other everyday tasks.

These tasks can be accomplished by a variety of software programs. For example, e-mail programs or applications facilitate the transmission of messages between users. Message-enabled scheduling programs allow users to request and schedule meetings and appointments via electronic messages. Computer programs known as desktop information managers attempt to coordinate the growing stream of electronic communications by incorporating e-mail, a calendar, task management, contact management, notes and journal features into a single application program.

The increased reliance on electronic messaging has resulted in a great increase in the number of electronic messages a user sends and receives daily. Users who send and receive a large number of e-mail messages would like an effective way to process their e-mail without spending a lot of time sorting through their in-box, deleting, filing, forwarding, and responding to their messages. Hence, a major problem with e-mail is that a user can become inundated with messages without an efficient and effective means to manage them. Time spent managing e-mail adversely impacts the productivity of businesses and adds to the already high stress levels of employees in the business environment.

E-mail has also become a vehicle for acts of electronic vandalism against businesses. Typically, destructive viruses are transported among network clients or peers via e-mail messaging. A virus typically infects not only the central server for a local network but also, through intra-messaging applications, the various nodes of the local network.

### SUMMARY OF THE INVENTION

These and other needs are addressed by the various embodiments and configurations of the present invention. The present invention is directed generally to an intelligent group assistant that archives electronic messages in a widely accessible (central) library or store and/or a message notification agent that provides notification messages to client or subscriber addressees that an electronic message has been received. The client or subscriber can then download the message, if desired, from the central library to a message store in the client or subscriber or view the message at the central message store. The use of “client” is further hereinafter intended to include “subscriber”.

In one embodiment, the group assistant parses the header and body of the e-mail message, extracts predetermined types of information, and provides the extracted information to the message notification agent. The message notification agent assembles the information in a notification message and forwards the notification message to the intended recipients of the e-mail message. The notification message content is a summarized, typically much shorter, (filtered) version of the content of the e-mail message. The full e-mail message can be downloaded by the server to an intended recipient at the request of the recipient. The message notification agent can be configured to periodically resend the notification message to the recipient if a flag is set by the sender. Viewing or deleting of the e-mail and/or replying to the e-mail can deactivate or change the flag. As will be appreciated, a flag is a variable indicating that a certain condition or state exists.

In another embodiment, a message manager is provided that presents a view of e-mail messages to the subscriber and is configured to remove or alter archived messages based on specified age limits. For example, the message manager can hide or remove an expired message, and/or provide a different view of deleted messages from undeleted messages. The view can also vary based upon the viewing device (e.g., personal computer, PALM™ device, WAP device, etc.) For example, the personal computer may provide detailed information about e-mail messages while a PALM™ device provides a less detailed, brief summary of the message. The age limits are typically selected by the sender of the message. Thus, a plurality of first messages associated with a first user can have differing expiration dates than a plurality of second messages associated with the first user stored in the same or a different library or queue. In one configuration, the message manager maintains a single copy of a message for all recipients of the message on that server.

The algorithms of the present invention can provide a number of benefits. First, the algorithm of the present invention, by using notification messages, can positively impact the productivity of businesses while reducing the already high stress levels of employees in the business environment. The algorithms discussed herein provide for an efficient and effective way for automated handling and filtering of e-mail. Second, the algorithms can reduce memory usage by storing e-mail as a single copy at a central library in the server and not at each client. Clients can download the e-mail at their discretion, which can greatly decrease memory usage at the client level. Third, by archiving messages at one location upon receipt the algorithms can limit the damage realized by viruses. When damage does occur, system administrators can more quickly repair the damage due to fewer computational resources being impacted compared to the damage experienced when e-mail messages and attachments are widely distributed throughout the internal network. Fourth, unlike existing e-mail management systems which are client-centric the algorithms of the present invention are server-centric. The algorithms accomplish this objective by using a concept of presence awareness in distributing e-mail messages. Fifth, the use of short notification messages to inform clients of e-mail receipt provides for ease of e-mail handling by users having slow dial-up connections and/or wireless devices with low bandwidth and processing capacity. Sixth, permitting senders to set age limits can provide significant reductions in e-mail loads for clients. Seventh, assisted messaging can provide intelligent notification at different types of end points based upon user configurations.

These and other advantages will be apparent from the disclosure of the invention(s) contained herein.

The above-described embodiments and configurations and advantages are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram of a client-server operating environment according to an embodiment of the present invention;

FIG. 2 illustrates various electronic message queues in the local store of an e-mail server;

FIG. 3 is a flow chart depicting the operation of the group assistant according to an embodiment of the present invention;

FIG. 4 is a flow chart depicting the operation of the message notification agent according to an embodiment of the present invention;

FIG. 5 is a flow chart depicting the operation of the message manager according to an embodiment of the present invention;

FIG. 6 is a block diagram of an e-mail packet according to an embodiment of the present invention; and

FIG. 7 is a block diagram depicting the operation of the message manager according to an embodiment of the present invention; and

FIG. 8 is a flow chart depicting the operation of the message manager according to an embodiment of the present invention.

### DETAILED DESCRIPTION

### Operating Environment

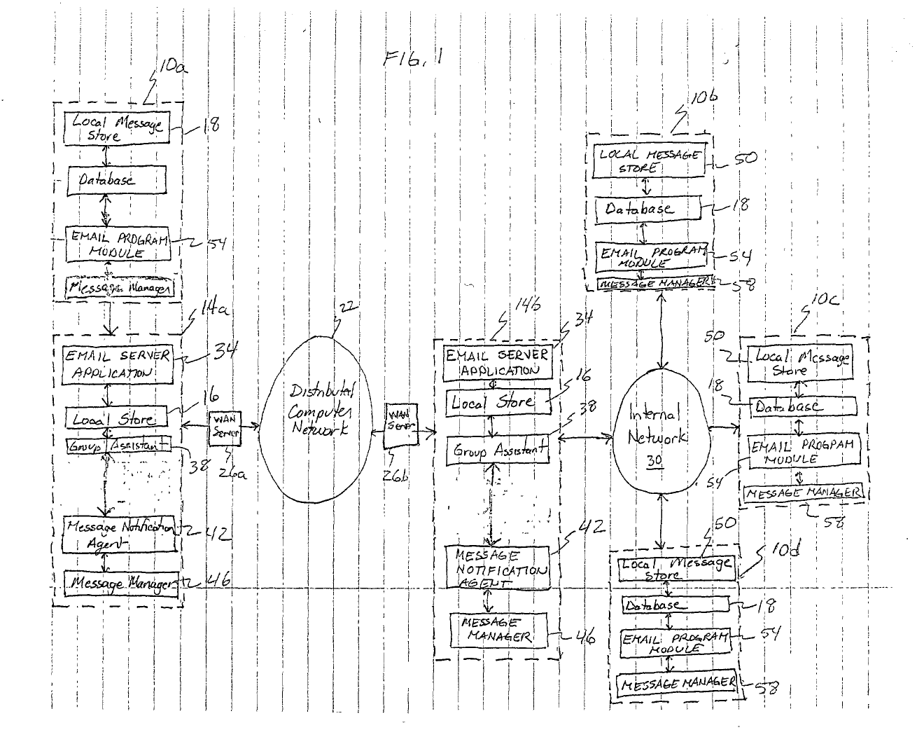

FIG. 1 illustrates a typical client-server environment in which the present invention operates.

A computer system (“client”) 10a, such as a personal computer or any device operable to communicate over a network, is connected to a server computer (“server”) 14a, which is typically a Local Area Network or LAN server (hereinafter referred to as LAN server). In typical applications, the server 14a stores files, such as e-mail, that are available to other computers connected to the LAN. For example, an e-mail server 14a manages message traffic and mail boxes for users. To obtain information from a server 14a, a client 10a makes a request for a file or information located on the server 14a using a specified protocol. As will be appreciated, the Internet uses a message standard, known as a Simple Mail Transfer Protocol (SMTP), which works in conjunction with a user's e-mail program and defines the control messages used by two computers to exchange e-mail messages. Upon reception of a properly formatted request, the server 14a downloads the file or information from a server store 16 to a database 18 located at the client. The server 14a is connected to a distributed computer network 22, such as the Internet, typically via a Wide Area Network or WAN server 26a, such as an Internet Service Provider, and enables the client 10a to communicate via the distributed computer network 22 with other computational components. As will be appreciated, WAN server 26a provides translation facilities or gateways that allow message exchange between different types of e-mail programs or applications using different messaging protocols and includes a message store for holding messages until delivery.

The client 10a communicates via the combination of the LAN server 14a, one or more WAN servers 26b, and the distributed computer network 22 to another LAN server 14b, such as a communication or an e-mail server. As shown, a WAN network server 26 is typically located between the distributed computer network 22 and each LAN server 14. The LAN server 14b is connected to an internal network 30 and enables the client 10a to communicate with clients 10b, 10c, and 10d. Clients 10b, 10c, and 10d can send information to the client 10a via the internal network 30 to the LAN server 14b. The LAN server 14b, in turn, forwards the information to the client 10a via the associated WAN server(s) 26a,b and the distributed computer network 22. The information is retrieved by the LAN server 14a and can be forwarded to the client 10a, when requested by the client 10a.

Each LAN server 14a and 14b and client 10a, 10b, 10c, and 10d includes a variety of software components. Specifically, servers 14a and 14b each include an email server application 34 (such as UNIX mail, Groupwise™ by Correl, and/or Microsoft Exchange™ by Microsoft Corporation, a local (central) message store 16 operable to store e-mail messages, a group assistant 38 operable to extract selected information from the messages received by the server 14 and store the (full text) messages to the local store 16, a message notification agent 42 operable to receive the selected information from the group assistant 38 and notify a client that an e-mail message intended for the client has been received by the server 14, and a message manager 46 for managing the messages in the local store 16. The clients 10a, 10b, 10c, and 10d each include a local message store 50 containing one or more queues of notification (or partial text e-mail) messages from the message notification agent 42, a database 18 for archiving full text e-mail messages, an e-mail program module 54 for interfacing with the e-mail server application 34, and a message manager 58 for managing the messages in local store 50 and/or database 18. As will be appreciated, the message manager 58 in each client 10a, 10b, 10c, and 10d can be omitted from the client. In that configuration, the message manager would reside only on servers 14a, 14b as message manager 46. The operations of the group assistant 38, message notification agent 42, and message manager 56 are discussed more fully below.

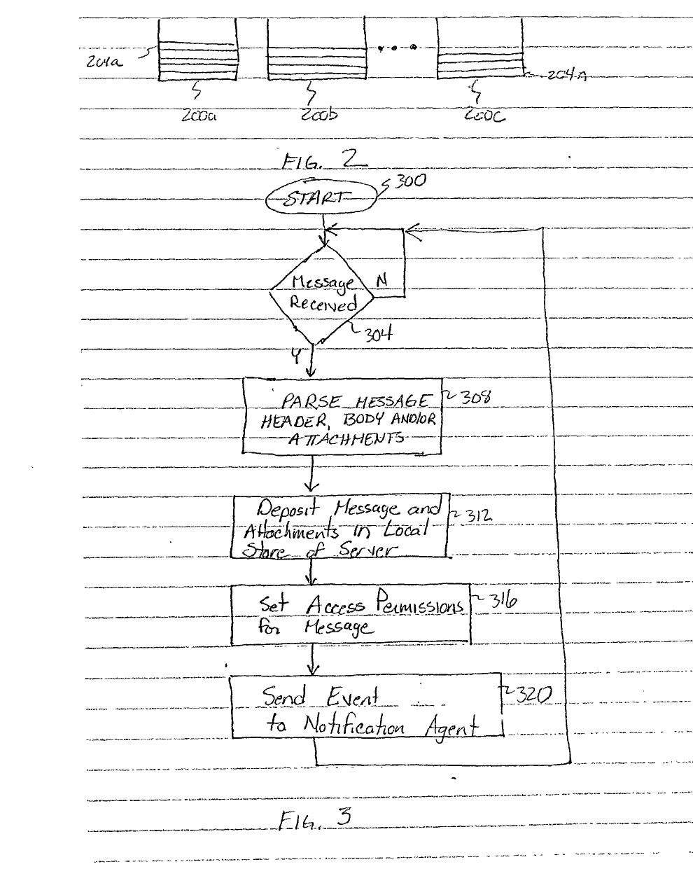

FIG. 2 depicts several message queues 200a, b, and c in the local store 16 of the LAN server 14. In one configuration, each queue corresponds to a status of e-mail messages 204a-n. The statuses of the messages include one or more of deleted, reviewed by one or more clients, and not yet reviewed by one or more clients. In another configuration, each queue 200 corresponds to a different client address in the internal network 30. In yet another configuration, a single queue is maintained in the local store 16, with the status of a message being reflected by corresponding information in the message's presentation layer (as defined by the Open Systems Interconnect Architecture).

### OPERATION OF THE GROUP ASSISTANT

Referring to FIG. 3, in the start step 300 the group assistant is initialized. This is typically performed when the server 14 is booted.

In step 304, the group assistant 38 determines whether a (new) email has been received. There are several ways that this determination can be performed. In one implementation, the client 10a directly addresses the message to the group assistant 38. In that event, the group assistant 38 appears to be the server 14b. In another implementation, the group assistant 38 accesses the local store 16 during a polling interval to determine if new messages have been received during the polling interval. Any new messages are retrieved by the group assistant 38 from the local store 16. In yet another implementation, a computational component in the server 14 notifies the group assistant 38 when a new message is received. The computational component can either identify the message (such as by providing the memory address of the message) to the group assistant 38 and/or provide a copy of the message to the group assistant.

If no message has been received, the group assistant 38 repeats step 304.

If a message has been received, the group assistant 38 in step 308 parses the message header, body, and/or attachment(s) for predetermined types of information. The header is typically parsed to identify the source address, destination address, the number of recipients, the subject of the message, the priority of the message, a timestamp associated with the message (e.g., a time of receipt of the message by the server 14b), any other flags of interest, and any other information of interest to the client.

To provide a more effective summary of the message, the body and/or attachments can be parsed or otherwise analyzed for predetermined terms or groups of terms, semantical relationships, pragmatical relationships, and/or syntactical relationships. As will be appreciated, “semantics” refers to the relationships of characters or groups of characters to their meanings, independent of the manner of their interpretation and use, “pragmatics” to the relationships of characters or groups of characters to their interpretation and use, and “syntax” to the relationship among characters or groups of characters, independent of their meanings or the manner of their interpretation and use. For example, if the subject field of the message contains insufficient information to properly identify the message to the client or if the subject field lacks predetermined types of information or even if the subject field is complete, the message body or payload can be parsed or otherwise examined for the above information. In one embodiment, a selected number of characters from the body of the message are extracted from the message. For example, the first ten words of the first line of the message body and/or attachment(s) thereto are extracted from the message. The number(s), lengths, and/or descriptions of the attachments can also be extracted from the body of the message and/or from the attachment(s) iteself.

In step 312 (which is optional), the group assistant 38 deposits the full text of the body of the message and attachments, all or selected parts of the header, and timestamp in the local store 16 of the server 14b. The data structures corresponding to the message and attachments can be configured in the store in accordance with any suitable indexing algorithm and/or database rules and/or policies. In step 316, the group assistant 38 further sets access permissions for the message in accordance with information in the presentation layer and header of the message.

In step 320, the group assistant 38 forwards an event to the notification agent 42 regarding the selected message and its attachments. The event typically includes the information extracted by the group assistant 38 from the message and its attachments.

The group assistant 38 then returns to step 304 and waits for and/or handles the next message to arrive at the server 14b.

### OPERATION OF THE MESSAGE NOTIFICATION AGENT

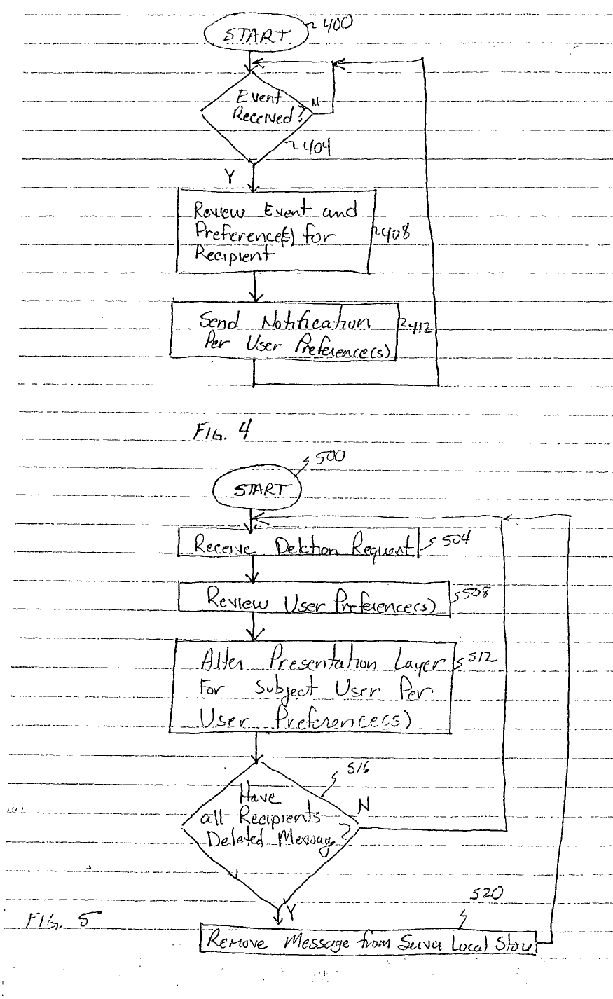

The operation of the message notification agent will now be described with reference to FIG. 4.

Referring to FIG. 4, in the start step 400 the message notification agent 42 is initialized. This is typically performed when the server 14b is booted.

In step 404, the message notification agent 42 determines whether a (new) event has been received. Message notification agent 42 repeats this step 404 until a new event has been received.

When a new event is received, the message notification agent 42 in step 408 reviews the event and the notification preference(s) or configuration for each recipient. For example, the receipient may designate that the notification is to be sent to one or more network addresses (or one or more computational components at different locations), such as a client and/or nonclient computer, and/or a communications device via a short message service or SMS.

In step 412, the message notification agent 42 assembles and sends the notification message in accordance with the user preferences. The notification message typically includes the source address, destination address(es), the number of recipients (or addressees), the subject of the message, the priority of the message, a timestamp associated with the message (e.g., a time of receipt of the message by the server 14b), any other flags of interest, and any other information of interest to the client. In one configuration, the notification is a summary of the full text e-mail message and incorporates, in addition to information from the subject field of the message header, text or other information extracted from the body or text of the message itself. For example, the notification message can include selected words or sentences from the body and/or attachment(s) of the message. This text is only a portion of the text of the message. The selected words or sentences indicates the context or content of the full text message.

The notification message is placed in a queue of notification messages in the local message store 50 of the respective client.

After the user views the notification message, the user can log into the server and perform a number of desired actions. By clicking on the notification message, the user can be linked directly to the server 14b and, after authentication of the user, can download the full text of the e-mail message from the local store 16 of the server 14b to the database 18 of the client. Alternatively, the user can change the permissions specified in the presentation layer to permit other (previously unauthorized) users to view the message. This can be done, for example, by forwarding a copy of the notification message to the desired user(s). When the desired user(s) click on the notification message, the permissions in the presentation layer is changed automatically to permit the user to access the full text e-mail message, and the full text e-mail message is downloaded to the user's computer. Alternatively, the user can download the full text e-mail message and forward the full text message to the other (unspecified) user. Alternatively, the user can access the information in the presentation layer and alter the information to provide access to the e-mail message by the other (unspecified) user. The user can send a reply e-mail message to the source of the e-mail message.

### OPERATION OF THE MESSAGE MANAGER

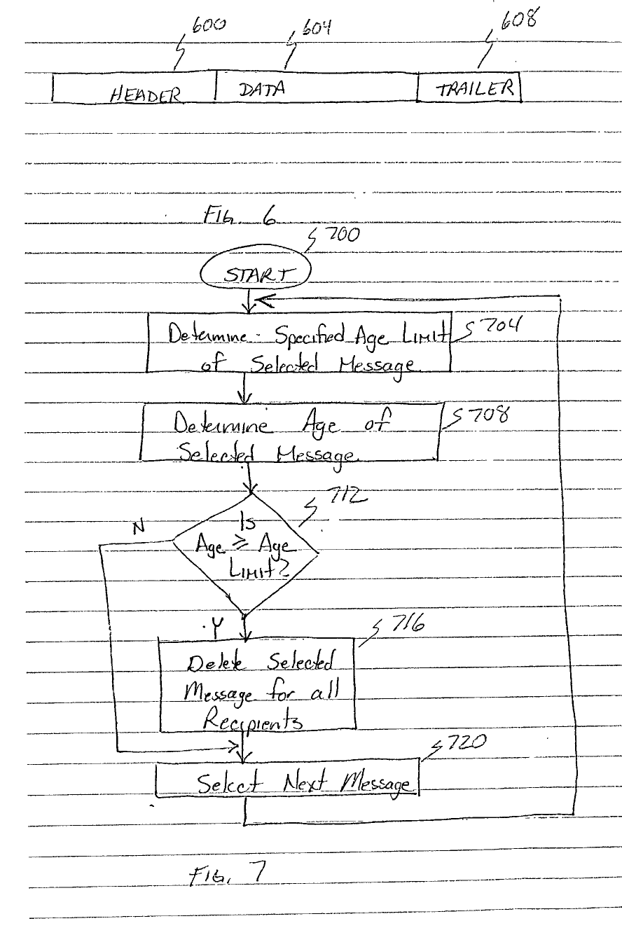

FIG. 5 shows one aspect of the operation of the message manager 46.

Referring to FIG. 4, the message manager 46 starts in step 500 by initializing itself at startup.

In step 504, the message manager 46 receives a deletion request from a user. The user (or client) requests that a notification message (and/or a full text e-mail message associated therewith) be deleted (or have the message status changed from a first status to a second status (deleted)). In step 508, the message manager 46 determines the user preference(s) for treatment of a deleted message. For example, the user can specify that deleted messages are to appear in a different font from reviewed and nonreviewed messages. Alternatively, the user could specify that deleted messages are to be hidden from view by the user. In step 512, the presentation layer is altered for the deleted message and the user requesting deletion in accordance with the user preferences.

In step 516, the message manager 46 determines whether all addressees of the message have deleted the message. If not, the message manager returns to step 504 to await the next deletion request. If so, the message manager proceeds to step 520 and removes or deletes the message from the server's local store 16 and from the local message store 50 and database 18 of the respective client computer. Thus, the full text e-mail message remains in the server's local store until each of the recipients has deleted the message.

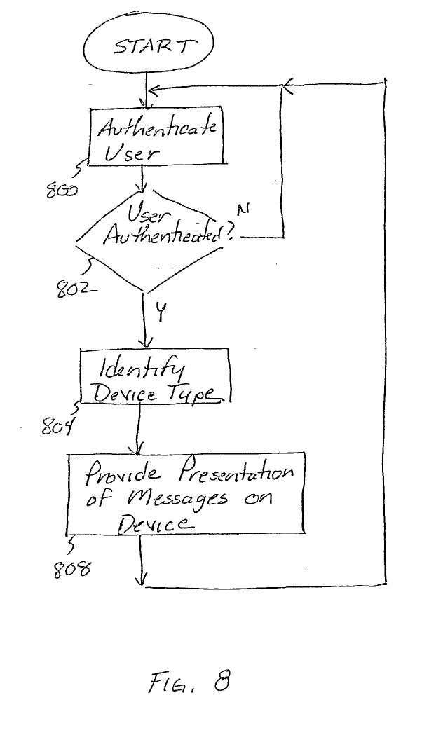

FIGS. 6 and 7 illustrate another operational aspect of the message manager 46.

A sender at client 10a determines a selected life or age limit of the e-mail message when the e-mail message is composed by the sender. This can be done by entering the age limit as a flag value (or setting the flag to a value related to the age limit) in the header 600, trailer 608, or body 604 (FIG. 6) of the message. If the age limit is entered as a flag value in the header, the age limit can be placed in the “X” field or extra flag field of the message header. This field is in most e-mail messaging protocols. If the age limit is entered as a flag value in the message text, the age limit is typically placed between or delineated by connectors in the message text (or an attachment thereto).

An example of such an age limit is where the sender has a time sensitive issue, such as a time for a meeting, in the text of the message. After a certain period of time, the message is no longer of interest to the recipient. The sender can thus limit the life of the message as he desires to accomodate such situations.

Referring now to FIG. 7, the message manager 46 is intialized in step 700 at start up.

In step 704, the message manager determines the specified age limit (if any) of the e-mail message and, in step 708, the age of the selected message (based on the timestamp of denoting the time of receipt of the message). The specified age limit is typically identified by parsing the header or trailer if the age limit is present as a flag in the header or trailer, respectively, or by examining the text (including attachment) of the message for a flag and/or connectors associated therewith.

When an age limit is specified, the message manager in step 712 determines if the specified age limit of the message is equal to or less than the actual age of the message. If the specified age limit has been met or exceeded by the actual age, the message manager 46 deletes the selected message for all recipients, based on the user specified preference(s) for the recipients (as discussed above). If the specified age limit has not been met or exceeded or after step 716, the message manager 46 selects a next message in the local store 16 of the server 14 or the database 18 or message store 50 of the client, whichever is appropriate, and repeats the foregoing steps. As will be appreciated, when a message has no specified age limit, the actual age is considered to be less than the specified age limit.

Accordingly, the messages in the server store 16, database 18, or message store 50 will typically have differing expiration times or age limits (or lives). Some messages will have no age limit specified while other messages will have differing age limits specified.

In one configuration, a default specified age limit is employed to prevent messages from remaining too long in the desired memory location. In that configuration, the inquiry in step 712 determines not only whether the sender specified age limit has been met or exceeded but also whether the default age limit has been met or exceeded. If either age has been met or exceeded, the message is deleted automatically from the applicable memory.

As will be appreciated, the client can access e-mail messages via the message manager 58 and/or 46 in addition to the conventional way of accessing e-mails. For example, FIG. 8 shows the algorithm for accessing the message manager 58 via the presentation layer. In step 800, the message manager 58 authenticates the user by any suitable technique; if authenticated, the message manager 58, in steps 802 and 804, identifies the type of client device; and the message manager in step 808 provides presentation of the e-mail messages as per the device capabilities/user preferences.

A number of variations and modifications of the invention can be used. It would be possible to provide for some features of the invention without providing others.

For example, one or more of the algorithms described herein can be used with any suitable network topology, such as a client/server or peer-to-peer network, a connection-oriented or connectionless network, and/or a synchronous or asynchronous network.

While the invention is described with reference to an application program that runs on an operating system in conjunction with a personal computer and in connection with a server, those skilled in the art will recognize that the invention also may be implemented in combination with other program modules. Generally, program modules include routines, operating systems, application programs, components, data structures, etc., that perform particular tasks or implement particular abstract data types.

Those skilled in the art will appreciate that the invention maybe practiced with other computer system configurations, including hand-held devices, multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules can be located in both local and remote memory storage devices. Execution of program modules can occur locally in a stand-alone manner or remotely in a client/server or peer-to-peer manner. Examples of such distributed computing environments include local area networks of an office, enterprise-wide computer networks, and the Internet.

The invention may be practiced with computational components using a variety of operating systems, protocols, and/or network applications. For example, the clients and/or servers can use UNIX mail (which is defined by SMTP), and Eudora (which is defined by Post Office Protocol or POP).

In another alternative embodiment, the group assistant and message notification agent configure the notification message so that the user can click on the notification message and the user will be automatically provided with the full text message by the server, even if the user clicks on the notification message from a nonclient computer or other type of communication device (i.e., a computer that is not part of the LAN server's internal network 30 (or local area network)). This is typically done by the group assistant 38, in response to the receipt of the reply message from the user, readdressing automatically the full text e-mail message and forwarding the e-mail message via the WAN server(s) 26 and the distributed computer network 22 (e.g., the Internet) to the network address or URL of the nonclient computer or communication device. The network address of the nonclient computer or communication device is typically maintained in the memory of the LAN server 14 as part of the specified user preferences. Examples of a non-personal-computer endpoint (as defined by user preferences) are a lap top computer, a pager, an SMS device, a PALM™ device, and a WAP device.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and\or reducing cost of implementation.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for processing a message received from a computational network, comprising:
receiving at least one network message, the network message comprising a header and at least one of a body and an attachment;
parsing the header and the at least one of a body and an attachment to locate predetermined types of information, including at least one intended network message recipient;
assembling the predetermined types of information in at least one notification message, the at least one notification message having a smaller byte size than the at least one network message; and
forwarding the at least one notification message to the at least one intended network message recipient.

2. The method of claim 1, wherein the at least one network message is received by a server, the at least one intended recipient is associated with a client of the server, and further comprising:
storing the at least one network message in a central message store in the server accessible by a plurality of clients.

3. The method of claim 1, further comprising:
determining a value of a flag in the at least one network message; and
when the state has a predetermined value, resending the notification message after a predetermined time interval has elapsed.

4. The method of claim 2, further comprising:
at least one of removing the message from the central message store and changing a presentation parameter associated with the at least one network message when the at least one network message is viewed by a client.

5. The method of claim 1, wherein first and second sets of network messages are associated with a client, the first and second sets of network messages are mutually exclusive, each message in the first and second sets of network messages have a corresponding predetermined expiration time, each message in the first set of network messages have a common first expiration time, each message in the second set of network messages have a common second expiration time, and the first and second expiration times are different.

6. The method of claim 5, wherein at least some of the expiration times in the first and/or second sets of network messages are set by a source of the at least one network message.

7. The method of claim 6, wherein the at least some of the expiration times are in the “X” fields of the network messages corresponding to the messages in the first and/or second sets of network messages.

8. The method of claim 5, further comprising:
comparing the first expiration time of a network message in the first set of network messages with an actual age of the corresponding network message; and
when the expiration time of the network message at least one of equals and exceeds the actual age, removing the corresponding network message from the first set of messages for all recipients for the corresponding network message.

9. The method of claim 5, further comprising a third set of network messages corresponding to the client, wherein each message in the third set of network messages has no predetermined expiration time associated therewith.

10. The method of claim 1, wherein in the parsing step the predetermined types of information comprise a type of computational component associated with the at least one intended network message recipient and further comprising:
selecting a presentation parameter for the at least one network message based on the computational component type.

11. The method of claim 1, wherein in the parsing step the predetermined types of information comprise at least one of terms, groups of terms, semantical relationships, pragmatical relationships, and syntactical relationships.

12. The method of claim 1, wherein the at least one network message comprises at least one packet.

13. The method of claim 1, wherein the at least one notification message comprises a source address of the network message, a destination address of the network message, a number of intended recipients of the network message, a subject of the network message, a priority of the network message, a timestamp associated with the network message, and a summary of the body of the network message.

14. The method of claim 1, further comprising, after the forwarding step, downloading the at least one network message to a client.

15. The method of claim 1, further comprising;
when a user selects a notification message, retrieving a network address of a nonclient computer associated with the user; and
forwarding the corresponding at least one network message to the nonclient computer.

16. The method of claim 15, wherein the nonclient computer is at least one of a pager, a PDA, a wireless telephone, a WAP, and an SMS device.

17. A system for processing a message received from a computational network, comprising:
means for receiving at least one network message, the network message comprising a header and at least one of a body and an attachment;
means for parsing the header and the at least one of a body and an attachment to locate predetermined types of information, including at least one intended network message recipient;
means for assembling the predetermined types of information in at least one notification message, the at least one notification message having a smaller byte size than the at least one network message; and
means for forwarding the at least one notification message to the at least one intended network message recipient.

18. The system of claim 17, wherein the receiving means is a server, the at least one intended recipient is associated with a client of the server, and further comprising:
a central message store in the server for storing the at least one network message, wherein the central message store in the server is accessible by a plurality of clients.

19. The system of claim 17, further comprising:
means for determining a value of a flag in the at least one network message; and
when the state has a predetermined value, means for resending the notification message after a predetermined time interval has elapsed.

20. The system of claim 17, wherein first and second sets of network messages are associated with a client, the first and second sets of network messages are mutually exclusive, each message in the first and second sets of network messages have a corresponding predetermined expiration time, each message in the first set of network messages have a common first expiration time, each message in the second set of network messages have a common second expiration time, and the first and second expiration times are different.

21. The system of claim 20, wherein at least some of the expiration times in the first and/or second sets of network messages are set by a source of the at least one network message.

22. The system of claim 21, wherein the at least some of the expiration times are in the “X” fields of the network messages corresponding to the messages in the first and/or second sets of network messages.

23. The system of claim 20, further comprising:
means for comparing the first expiration time of a network message in the first set of network messages with an actual age of the corresponding network message; and
when the expiration time of the network message at least one of equals and exceeds the actual age, means for removing the corresponding network message from the first set of messages for all recipients for the corresponding network message.

24. The system of claim 20, further comprising a third set of network messages corresponding to the client, wherein each message in the third set of network messages has no predetermined expiration time associated therewith.

25. The system of claim 17, wherein the predetermined types of information comprise a type of computational component associated with the at least one intended network message recipient and further comprising:
means for selecting a presentation parameter for the at least one network message based on the computational component type.

26. The system of claim 17, wherein the predetermined types of information comprise at least one of terms, groups of terms, semantical relationships, pragmatical relationships, and syntactical relationships.

27. The system of claim 17, wherein the at least one notification message comprises a source address of the network message, a destination address of the network message, a number of intended recipients of the network message, a subject of the network message, a priority of the network message, a timestamp associated with the network message, and a summary of the body of the network message.

28. The system of claim 17, further comprising;
when a user selects a notification message, means for retrieving a network address of a nonclient computer associated with the user; and
second means for forwarding the corresponding at least one network message to the nonclient computer.

29. The system of claim 28, wherein the nonclient computer is at least one of a pager, a PDA, a wireless telephone, a WAP, and an SMS device.

30. A system for processing a message received from a computational network, comprising:
an input port configured to receive at least one network message to a common set of recipients, the network message comprising a header and at least one of a body and an attachment;
a group assistant configured to parse the header and the at least one of a body and an attachment to locate predetermined types of information, including at least one intended network message recipient; and
a message notification agent configured to assemble the predetermined types of information in at least one notification message, the at least one notification message omitting at least some of the information in the at least one network message, and to forward the at least one notification message to the at least one intended network message recipient.

31. The system of claim 30, wherein the input port is part of a server, the at least one intended recipient is associated with a client of the server, and further comprising:
a central message store in the server configured to store the at least one network message, wherein the central message store in the server is accessible by a plurality of clients.

32. The system of claim 30, further comprising:
a message manager configured to determine a value of a flag in the at least one network message and, when the state has a predetermined value, to resend the notification message after a predetermined time interval has elapsed.

33. The system of claim 30, wherein first and second sets of network messages are associated with a client, the first and second sets of network messages are mutually exclusive, each message in the first and second sets of network messages have a corresponding predetermined expiration time, each message in the first set of network messages have a common first expiration time, each message in the second set of network messages have a common second expiration time, and the first and second expiration times are different.

34. The system of claim 33, wherein at least some of the expiration times in the first and/or second sets of network messages are set by a source of the at least one network message.

35. The system of claim 34, wherein the at least some of the expiration times are in the “X” fields of the network messages corresponding to the messages in the first and/or second sets of network messages.

36. The system of claim 33, wherein the message manager is configured to compare the first expiration time of a network message in the first set of network messages with an actual age of the corresponding network message; and, when the expiration time of the network message at least one of equals and exceeds the actual age, to remove the corresponding network message from the first set of messages for all recipients for the corresponding network message.

37. The system of claim 33, further comprising a third set of network messages corresponding to the client, wherein each message in the third set of network messages has no predetermined expiration time associated therewith.

38. The system of claim 30, wherein the predetermined types of information comprise a type of computational component associated with the at least one intended network message recipient and further comprising a message manager configured to select a presentation parameter for the at least one network message based on the computational component type.

39. The system of claim 30, wherein the predetermined types of information comprise at least one of terms, groups of terms, semantical relationships, pragmatical relationships, and syntactical relationships.

40. The system of claim 30, wherein the at least one notification message comprises a source address of the network message, a destination address of the network message, a number of intended recipients of the network message, a subject of the network message, a priority of the network message, a timestamp associated with the network message, and a summary of the body of the network message.

41. The system of claim 30, further comprising;
when a user selects a notification message, the group assistant is configured to retrieve a network address of a nonclient computer associated with the user and forward the corresponding at least one network message to the nonclient computer.

42. The system of claim 41, wherein the nonclient computer is at least one of a pager, a PDA, a wireless telephone, a WAP, and an SMS device.
